(19) United States
(12) Patent Application Publication
(10) Pub. No.: US 2018/0029832 A1
(43) Pub. Date: Feb. 1, 2018

(54) VEHICLE AND METHOD FOR ELEVATOR SYSTEM INSTALLATION

(71) Applicant: OTIS ELEVATOR COMPANY, Farmington, CT (US)

(72) Inventors: Richard N. Fargo, Plainville, CT (US); Tadeusz Witczak, Bethel, CT (US); Martin J. Hardesty, West Hartford, CT (US); Zbigniew Piech, Cheshire, CT (US)

(21) Appl. No.: 15/548,855

(22) PCT Filed: Feb. 4, 2016
(86) PCT No.: PCT/US2016/016552

§ 371 Date: Aug. 4, 2017

Related U.S. Application Data
(60) Provisional application No. 62/112,247, filed on Feb. 5, 2015.

(51) Int. Cl. B66B 19/00; B66B 11/04; E04H 1/00; B66B 11/02

(52) U.S. Cl. CPC B66B 19/00; B66B 11/0213; B66B 11/0407; E04H 1/00; B66B 9/003

(57) ABSTRACT

A method of installing an elevator system in a hoistway includes loading an elevator car with elevator system components for installation. The elevator car includes a first deck including one or more linear drive elements operably connected to a linear drive system at the hoistway and a second deck abutting the first deck, and separated from the first deck by a floor. The second deck is at least partially open at one side to allow access to the hoistway for installation of elevator system components in the hoistway. The elevator car is urged along the hoistway to an installation zone and the elevator system components are installed to the hoistway from the at least partially open second deck.

### BACKGROUND

The subject matter disclosed herein relates generally to the field of elevators, and more particularly to a multicar, ropeless elevator system.

Ropeless elevator systems, also referred to as self-propelled elevator systems, are useful in certain applications (e.g., high rise buildings) where the mass of the ropes for a roped system is prohibitive and there is a desire for multiple elevator cars to travel in a single lane. There exist ropeless elevator systems in which a first lane is designated for upward traveling elevator cars and a second lane is designated for downward traveling elevator cars. A transfer station at each end of the hoistway is used to move cars horizontally between the first lane and second lane.

Additionally, present elevator system installation methods require either scaffolding, hoists installed at a top of the hoistway and/or a jump lift method, in which a machine room is repeatedly relocated up the hoistway as upward construction of the building progresses. These methods require significant labor for the scaffolding installation and/or repeated jump lift re-positioning, and in most cases elevator installation occurs only after the building is at full height. Further, each of these installation methods has limitations.

### BRIEF SUMMARY

In one embodiment, an elevator car for an elevator system includes a first deck including one or more linear drive elements operably connected to a linear drive system at a hoistway and a second deck abutting the first deck, and separated from the first deck by a floor. The second deck is at least partially open at one side to allow access to the hoistway for installation of elevator system components in the hoistway.

Alternatively or additionally, in this or other embodiments the second deck is an upper deck and the first deck is a lower deck.

Alternatively or additionally, in this or other embodiments a pass through opening is located between the first deck and the second deck to move elevator system components between the first deck and the second deck.

Alternatively or additionally, in this or other embodiments a floor opening is disposed at a first deck floor to allow passage of elevator system components between the hoistway and the first deck.

Alternatively or additionally, in this or other embodiments the linear drive elements are secondary portions of a linear motor system interactive with a plurality of primary portions secured in the hoistway to urge motion of the elevator car along the hoistway.

Alternatively or additionally, in this or other embodiments a hoist is located at the second deck to move and position elevator system components for installation.

Alternatively or additionally, in this or other embodiments the elevator system is a multi-car ropeless elevator system.

Alternatively or additionally, in this or other embodiments one of the first deck and/or the second deck is collapsible to allow the elevator car to pass through a transfer station at a hoistway end.

Alternatively or additionally, in this or other embodiments the elevator car includes brakes and/or safeties to stop and hold the elevator car at a selected position in the hoistway.

In another embodiment, a method of installing an elevator system in a hoistway includes loading an elevator car with elevator system components for installation. The elevator car includes a first deck including one or more linear drive elements operably connected to a linear drive system at the hoistway and a second deck abutting the first deck, and separated from the first deck by a floor. The second deck is at least partially open at one side to allow access to the hoistway for installation of elevator system components in the hoistway. The elevator car is urged along the hoistway to an installation zone and the elevator system components are installed to the hoistway from the at least partially open second deck.

Alternatively or additionally, in this or other embodiments installing the elevator system components further includes affixing rail segments to the hoistway and affixing linear drive system components to the hoistway. The linear drive system components are made operational so the elevator car may be driven along the newly installed rail segments.

Alternatively or additionally, in this or other embodiments the linear drive system components include primary portions of a linear drive system interactive with secondary portions affixed to the elevator car.

Alternatively or additionally, in this or other embodiments the rail segments are aligned with previously installed rail segments prior to affixing the rail segments to the hoistway.

Alternatively or additionally, in this or other embodiments the linear drive system components are connected to a temporary electrical power line to provide electrical power to the linear drive system components.

Alternatively or additionally, in this or other embodiments the elevator car is driven along the hoistway to a second installation zone via the linear drive system components powered by the temporary electrical power line.

Alternatively or additionally, in this or other embodiments the linear drive system components are sequentially disconnected from the temporary electrical power line and connected to a permanent electrical power line fixed in the hoistway.

Alternatively or additionally, in this or other embodiments the elevator car is loaded with additional elevator system components for installation prior to proceeding to the second installation zone.

Alternatively or additionally, in this or other embodiments the second deck is an upper deck and the first deck is a lower deck.

Alternatively or additionally, in this or other embodiments additional elevator cars are operated in the hoistway outside of the installation zone during installation.

Alternatively or additionally, in this or other embodiments additional elevator cars are operated below the installation zone during installation.

Alternatively or additionally, in this or other embodiments elevator system components are passed through a pass through opening between the first deck and the second deck prior to installation from the second deck.

Alternatively or additionally, in this or other embodiments a hoist affixed to the second deck is utilized to lift and position the elevator system components for installation.

Alternatively or additionally, in this or other embodiments the elevator system is a multi-car ropeless elevator system.

Alternatively or additionally, in this or other embodiments elevator system components are conveyed to the installation car via a supply car travelling along the hoistway, and are transferred from the supply car to the installation car.

In yet another embodiment, a method of constructing a structure includes loading an elevator car with elevator system components for installation. The elevator car includes a first deck including one or more linear drive elements operably connected to a linear drive system at the hoistway and a second deck abutting the first deck, and separated from the first deck by a floor, the second deck at least partially open at one side to allow access to the hoistway for installation of elevator system components in the hoistway. The elevator car is urged along the hoistway to an installation zone via the linear drive system. The elevator system components are installed to the hoistway from the at least partially open second deck. Building materials for the structure are conveyed along the hoistway via the installation car. The building materials are installed at a construction zone of the structure.

Alternatively or additionally, in this or other embodiments the structure is constructed incrementally along with the elevator system component installation.

### BRIEF DESCRIPTION OF THE DRAWINGS

FIG. 1 depicts a multicar elevator system in an exemplary embodiment;

FIG. 2 depicts an embodiment of an installation car for an elevator system;

FIG. 3 depicts another embodiment of an installation car for an elevator system;

FIG. 4 depicts a method for installation of hoistway components for an elevator system; and

FIG. 5 depicts another embodiment of a multicar elevator system.

The detailed description explains the invention, together with advantages and features, by way of examples with reference to the drawings.

### DETAILED DESCRIPTION

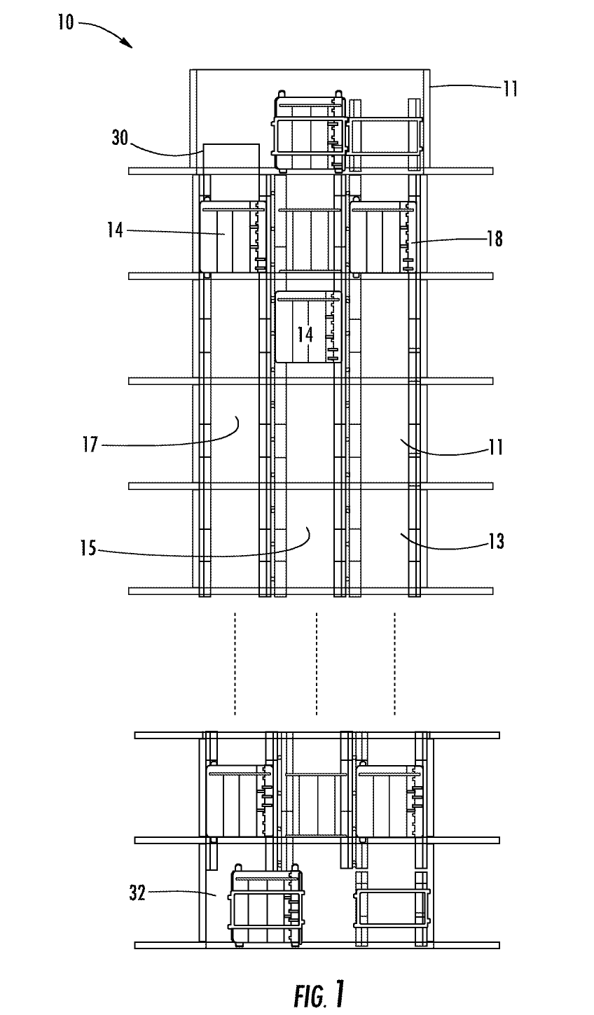

FIG. 1 depicts a multicar, ropeless elevator system 10 in an exemplary embodiment. Elevator system 10 includes a hoistway 11 having a plurality of lanes 13, 15 and 17. While three lanes are shown in FIG. 1, it is understood that embodiments may be used with multicar, ropeless elevator systems have any number of lanes. In each lane 13, 15, 17, multiple elevator cars 14 can travel in one direction, i.e., up or down, or multiple cars within a single lane may be configured to move in opposite directions. For example, in FIG. 1 cars 14 in lanes 13 and 17 travel up and cars 14 in lane 15 travel down. One or more cars 14 may travel in a single lane 13, 15, and 17.

Above the top floor is an upper transfer station 30 to impart horizontal motion to elevator cars 14 to move elevator cars 14 between lanes 13, 15 and 17. It is understood that upper transfer station 30 may be located at the top floor, rather than above the top floor. Below the first floor is a lower transfer station 32 to impart horizontal motion to elevator cars 14 to move elevator cars 14 between lanes 13, 15 and 17. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32 are configured to impart horizontal motion to the elevator cars 14 at the respective transfer station, thus enabling transfer from one lane to another lane at an intermediary point within the elevator shaft 11. Further, although not shown in FIG. 1, the elevator cars 14 are configured to stop at a plurality of floors to allow ingress to and egress from the elevator cars 14.

Elevator cars 14 are propelled within lanes 13, 15, 17 using a propulsion system such as a linear, permanent magnet motor system having a primary, fixed portion, or first part 16, and a secondary, moving portion, or second part 18. The first part 16 is a fixed part because it is mounted to a portion of the lane, and the second part 18 is a moving part because it is mounted on the elevator car 14 that is movable within the lane.

The first part 16 includes windings or coils mounted on a structural member, and may be mounted at one or both sides of the lanes 13, 15, and 17, relative to the elevator cars 14. Specifically, first parts 16 will be located within the lanes 13, 15, 17, on walls or sides that do not include elevator doors.

The second part 18 includes permanent magnets mounted to one or both sides of cars 14, i.e., on the same sides as the first part 16. The second part 18 engages with the first part 16 to support and drive the elevators cars 14 within the lanes 13, 15, 17. First part 16 is supplied with drive signals from one or more drive units to control movement of elevator cars 14 in their respective lanes through the linear, permanent magnet motor system. The second part 18 operatively connects with and electromagnetically operates with the first part 16 to be driven by the signals and electrical power. The driven second part 18 enables the elevator cars 14 to move along the first part 16 and thus move within a lane 13, 15, and 17.

Those of skill in the art will appreciate that the first part 16 and second part 18 are not limited to this example. In alternative embodiments, the first part 16 may be configured as permanent magnets, and the second part 18 may be configured as windings or coils. Further, those of skill in the art will appreciate that other types of propulsion may be used without departing from the scope of the invention. Further, the components of the first part 16 and second part 18 may be reversed, such that fixed, first part includes permanent magnets and the moving, second part includes windings or coils.

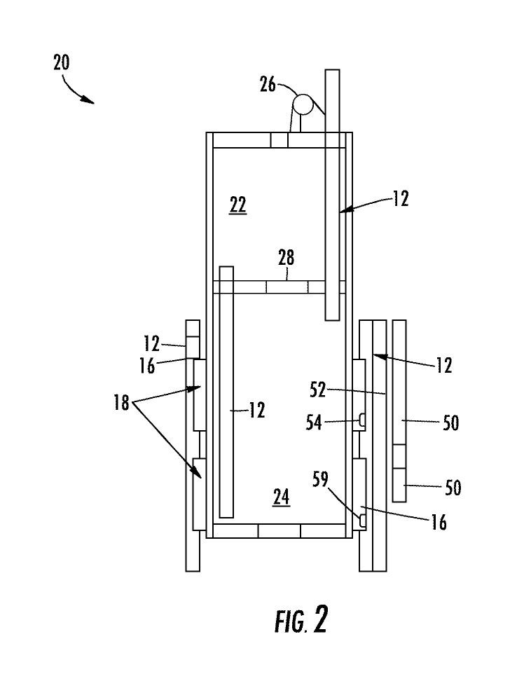

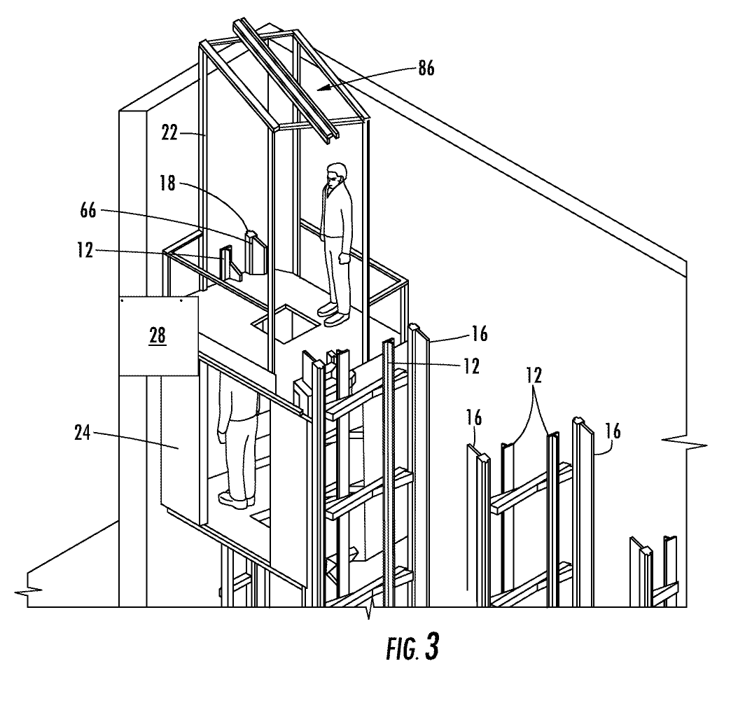

Referring now to FIGS. 2 and 3, in an exemplary embodiment, an installation car 20 is utilized for installation of elevator system 10 components, including rails 12 and primary portions 16, in the lanes 13, 15, 17. The installation car includes an upper deck 22 and a lower deck 24. The lower deck 24 is configured as a regular car 14, and may be used as such when not utilized for installation of elevator system components. During construction or installation operations, the lower deck 24 may be utilized for parts and equipment storage, for example, storage of rail 12 segments, primary portions 16, wiring harnesses and connectors (not shown) and the like. The upper deck 22 has an open configuration on at least one side to allow access to the hoistway, and is configured to support an overhead crane 26 or other hoist or handling equipment used for lifting and moving components to be installed in the hoistway 11. In other embodiments, the components may be lifted into the installation car 20 from below using, for example, a jacking mechanism. In some embodiments, the lower deck 24 is open or partially open to allow access to the hoistway 11 from the lower deck 24. The upper deck 22 may be also used for component storage as well as be equipped with needed tools. There may be one or more pass through openings 28 between the upper deck 22 and the lower deck 24 to allow passage of components and/or personnel between the lower deck 24 and the upper deck 22. In some embodiments, the pass through 28 opening is closable when not in use. In some embodiments, a closable floor opening 34 is provided in a floor 36 of the lower deck 24 to allow loading of components into the lower deck 24 from below. In some embodiments, the upper deck 22 is retractable to allow the installation car 20 to make use of the transfer station 32.

The installation car 20 is equipped with linear motor elements to drive the installation car 20 along the rails 12. The linear motor drive for the installation car 20 may be, for example, secondary portion 18/primary portion 16 pair or other linear drive system such as a magnetic screw drive. In some embodiments, secondary portions 18 are secured to the installation car 20 are interactive with primary portions 16 installed in the hoistway 11 to drive the installation car along rails 12. In some embodiments, the secondary portions 18 are secured at a lower deck 24 of the installation car 20, so that the upper deck 22 is positionable at a hoistway portion where rail segments, primaries and other components have yet to be installed. Further, the installation car 20 may include other basic elevator car 14 components such as brakes, safeties, control panel and doors. However, they may be modified from elevator car 14 to support the purpose of the installation car 20. For example, parts may be modified to support heavier loads, and the installation car 20 may have an increased number of secondary portions 18 or increased secondary portion 18 length, compared to elevator car 14, in order to increase the lifting capacity to more than the rated duty of the elevator car 14 to be installed later. Further, the brakes and/or safeties may be modified to stop and hold a heavily loaded installation car 20, which may have a weight greater than a service weight of the regular car 14.

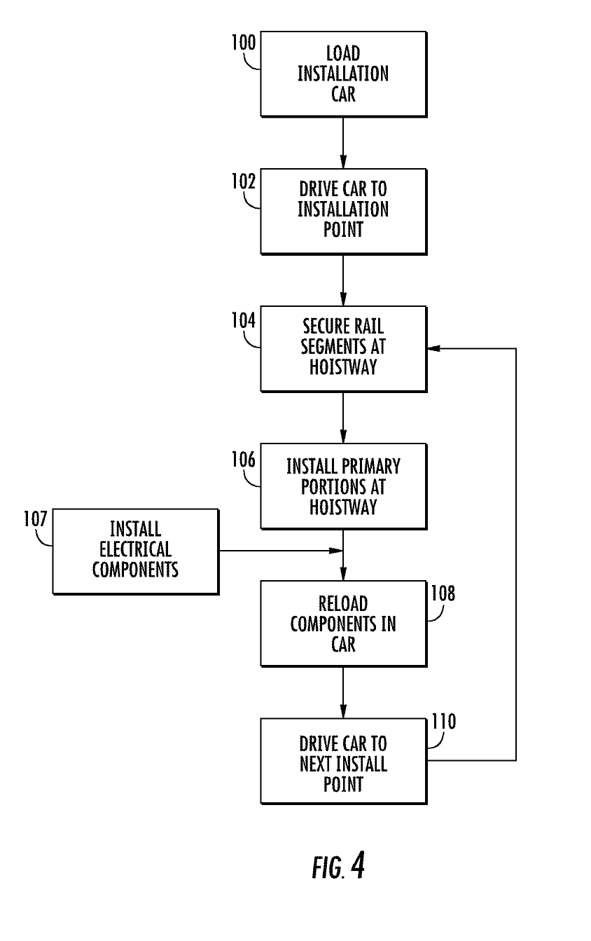

The installation car 20 is utilized to install the elevator system 10 components in segments as a building is raised, rather than waiting for installation of the elevator system 10 when the building has achieved its completed height. An exemplary installation method is outlined in FIG. 4. Initially, referring to block 100, the installation car 20 is loaded with components including primary portions 16, rail 12 segments, electrical cables and/or connectors and other components as needed. In some embodiments, the installation car 20 is loaded with components sufficient to install one floor of rise to the elevator system 10. In addition to utilizing the installation car 20 for installation and construction of the elevator system 10, the installation car 20 may similarly be utilized for construction of the building. Building components and materials may be loaded into the installation car 20 and shuttled or transported via the installation car 20 to a construction floor or area where the materials may be unloaded from the installation car 20 and utilized at the construction area. In other embodiments, components for elevator system installation and/or building construction are supplied to the installation car 20 via a second installation car 20 or a supply car travelling along the hoistway 11. Components are then transferred from the supply car to the installation car 20 for installation.

In block 102, the installation car 20 is moved upward in the hoistway 11 via secondary portion 18 interaction with primary portions 16 previously installed, and is stopped at an installation point such that the installation point is accessible from the upper deck 22. In block 104, the rail 12 segments are moved into position and secured to the hoistway 11, in some embodiments with the use of the overhead crane 26. Further, in some embodiments, the rail 12 segments may be aligned to previously installed rail 12 segments with the aide of an optical alignment device, or other alignment mechanism. In block 106, the primary portions 16 are installed to hoistway 11, in some embodiments with the aid of an optical alignment device, and electrical connections are made to previously installed primary portions 16, so that the elevator system 10 is then operational to the newly installed floor level.

Further, in block 107, electrical components for operation of the primary portions 16 are installed, such as electrical wiring and controllers or drives for the primary portions. In an exemplary embodiment, a permanent electrical buss segment 50 is installed in the hoistway 11 and secured to previously installed permanent buss segments 50. In some embodiments, the permanent buss segments 50 are configured to provide power, in some cases, direct current or alternating current. The permanent buss segments 50 are not operational during installation to reduce safety hazards during the installation. To power the primary portions 16 during installation, one or more temporary, light gauge, installation wires 52 are utilized. These installation wires 52 are connected to a power source (not shown), and further connected to installed primary portions 16 via drives 54 to transmit alternating current to the primary portions 16, in some embodiments. Connection of the installation wires 52 to the primary portions 16 makes the installed primary portions 16 operational.

In block 108, the installation car 20 is moved upward to the next installation point, or alternatively returned downward to a component storage location to be loaded with more components for installation. In block 110, the installation car 20 is moved upward to the next installation point, and installation of the components is repeated as above. In this way, the installation of the elevator progresses from bottom to top of the hoistway 11. Once the finished height is reached, the installation car 20 works its way down the hoistway 11, incrementally disconnecting the installation wires 52 from the primary portions 16 and connecting the permanent buss segments to the primary portions 16. When the final permanent buss segment 50 is connected to the primary portions 16, the permanent buss segments 50 are energized.

Further, in some embodiments, the installation car 20 allows the hoistway 11 and building to be constructed incrementally. Initially, a first portion of the hoistway 11 and building may be constructed. Then, the installation car 20 is used to convey both elevator system components and hoistway and building materials to a construction zone. A second portion of the building and hoistway 11 are erected and elevator system components are installed therein and activated as described above. Once work at the second portion is accomplished, the installation car 20 may be driven to a third portion where the construction and installation sequence is again performed. This process may then continue until completion of the building.

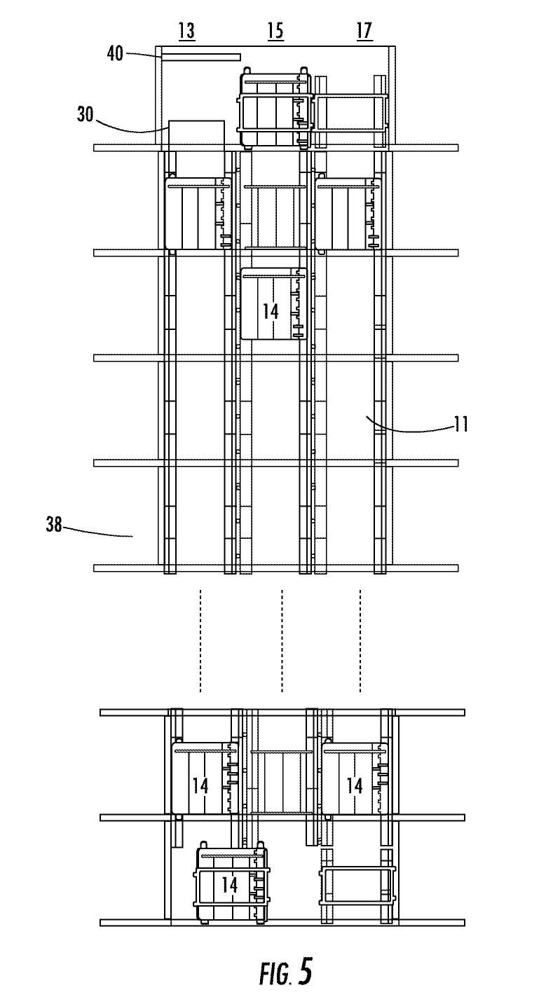

Referring now to FIG. 5, as height increases, components may be shuttled to an intermediate staging floor 38, so that the installation car 20 does not need to travel to a bottom of the hoistway each time more installation materials are to be loaded onto the installation car 20. This also allows for additional cars 14 to be operated below the staging floor 38 in a normal operating mode, conveying passengers along the elevator system 10. Physical barriers in the hoistway 11 and/or lockout in controls are utilized to isolate installation car 20 travel from normal car 14 travel. Further, while in the embodiments herein the installation car 20 is described as having two decks, it is to be appreciated that three or more decks may be utilized in other embodiments. Additionally, to prevent water ingress to the hoistway 14 during building construction, a movable cover 40 may be placed above the installation point, and may be movable as installation of the elevator system 10 progresses upward.

One of the benefits coming from this solution is safety of personnel working in hoistway 14. When the installation car 20 reaches the construction zone and is secured (on brakes), the installation car 20 creates a working platform that can be safely accessed from a floor below the construction zone. The upper deck 22 may be surrounded with proper height fence/balustrade for personnel safety. With proper height of this kind of protection, risk of work at height would be significantly reduced for personnel working on upper deck 22 (above the partially finished hoistway).

Another benefit of this solution is possibility of creating small fully separated construction zones. When the installation car 20 is placed in the construction zone, working position in the hoistway 14 below and above as well as neighboring hoistways 14 may be protected with nets or barriers. This would prevent injuries caused by falling objects to personnel working on the installation car 20 as well as other to users of the hoistway 14. This solution allows for safe use of the hoistway 14 below in regular system operation mode while not impacting traffic as the installation car 20 can be self-efficient with its part storage.

The installation car 20 eliminates the need for temporary work, such as scaffolding, which will be removed later. The process enables loading of the hoistway 14 material at a lower landing, with no need for cranes or separate service elevators to raise the materials. In addition, the installation car 20 can be used for general construction purposes of moving people or materials, to nearly the highest structurally complete floor of the building, while the building is under construction. Since power wires are brought up the building with the other equipment, the system can be operational well before building power is available at the highest floor for the hoistway 14. This can improve the installation schedule by several months.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator car for an elevator system comprising:
a first deck including one or more linear drive elements operably connected to a drive system at a hoistway; and
a second deck abutting the first deck, and separated from the first deck by a floor, the second deck at least partially open at one side to allow access to the hoistway for installation of elevator system components in the hoistway.

2. The elevator car of claim 1, wherein the second deck is an upper deck and the first deck is a lower deck.

3. The elevator car of claim 1, further comprising a pass through opening between the first deck and the second deck to move elevator system components between the first deck and the second deck.

4. The elevator car of any of claim 1, further comprising a floor opening in a first deck floor to allow passage of elevator system components between the hoistway and the first deck.

5. The elevator car of any of claim 1, wherein the linear drive elements are secondary portions of a linear motor system interactive with a plurality of primary portions secured in the hoistway to urge motion of the elevator car along the hoistway.

6. The elevator car of any of claim 1, further comprising a hoist at the second deck to move and position elevator system components for installation.

7. The elevator car of any of claim 1, wherein the elevator system is a multi-car ropeless elevator system.

8. The elevator car of any of claim 1, wherein one of the first deck and/or the second deck is collapsible to allow the elevator car to pass through a transfer station at a hoistway end.

9. The elevator car of any of claim 1, wherein the elevator car includes brakes and/or safeties to stop and hold the elevator car at a selected position in the hoistway.

10. A method of installing an elevator system in a hoistway comprising:
loading an elevator car with elevator system components for installation, the elevator car including:
a first deck including one or more linear drive elements operably connected to a linear drive system at the hoistway; and
a second deck abutting the first deck, and separated from the first deck by a floor, the second deck at least partially open at one side to allow access to the hoistway for installation of elevator system components in the hoistway;
urging the elevator car along the hoistway to an installation zone via the linear drive system; and
installing the elevator system components to the hoistway from the at least partially open second deck.

11. The method of claim 10, wherein installing the elevator system components further includes:
affixing rail segments to the hoistway;
affixing linear drive system components to the hoistway; and
making the linear drive system components operational so the elevator car may be driven along the newly installed rail segments.

12. The method of claim 11, wherein the drive system components include primary portions of a linear drive system interactive with secondary portions affixed to the elevator car.

13. The method of claim 11, further comprising aligning the rail segments with previously installed rail segments prior to affixing the rail segments to the hoistway.

14. The method of any of claim 10, further comprising connecting the linear drive system components to a temporary electrical power line to provide electrical power to the linear drive system components.

15. The method of claim 14, further comprising driving the elevator car along the hoistway to a second installation zone via the linear drive system components powered by the temporary electrical power line.

16. The method of claim 14, further comprising:
sequentially disconnecting the linear drive system components from the temporary electrical power line; and
connecting the linear drive system components to a permanent electrical power line fixed in the hoistway.

17. The method of any of claim 14, further comprising loading the elevator car with additional elevator system components for installation prior to proceeding to the second installation zone.

18. The method of any of claim 10, wherein the second deck is an upper deck and the first deck is a lower deck.

19. The method of any of claim 10, further comprising operating additional elevator cars outside of the installation zone in the hoistway during installation.

20. The method of claim 19 further comprising operating additional elevator cars below the installation zone during installation.

21. The method of any of claim 10, further comprising passing elevator system components through a pass through opening between the first deck and the second deck prior to installation from the second deck.

22. The method of any of claim 10, further comprising utilizing a hoist affixed to the second deck to lift and position the elevator system components for installation.

23. The method of any of claim 10, wherein the elevator system is a multi-car ropeless elevator system.

24. The method of any of claim 10, further comprising:
conveying elevator system components to the installation car via a supply car travelling along the hoistway; and
transferring the elevator system components from the supply car to the installation car.

25. A method of constructing a structure comprising:
loading an elevator car with elevator system components for installation, the elevator car including:
a first deck including one or more linear drive elements operably connected to a linear drive system at the hoistway; and
a second deck abutting the first deck, and separated from the first deck by a floor, the second deck at least partially open at one side to allow access to the hoistway for installation of elevator system components in the hoistway;
urging the elevator car along the hoistway to an installation zone via the linear drive system;
installing the elevator system components to the hoistway from the at least partially open second deck;
conveying building materials for the structure along the hoistway via the installation car; and
installing the building materials at a construction zone of the structure.

26. The method of claim 25, wherein the structure is constructed incrementally along with the elevator system component installation.
